(19) United States
(12) Patent Application Publication
(10) Pub. No.: US 2017/0277327 A1
(43) Pub. Date: Sep. 28, 2017

(54) METHOD AND TERMINAL FOR DETECTING GRIP STRENGTH

(71) Applicants: Le Holdings (Beijing) Co., Ltd., Beijing (CN); Lemobile Information Technology (Beijing) Co., Ltd., Beijing (CN)

(72) Inventor: Haosen SUO, Beijing (CN)

(21) Appl. No.: 15/264,452

(22) Filed: Sep. 13, 2016

Related U.S. Application Data
(63) Continuation-in-part of application No. PCT/CN2016/096284, filed on Aug. 22, 2016.

(30) Foreign Application Priority Data
Mar. 25, 2016 (CN) 2016101803069

(51) Int. Cl. G06F 3/041; G06F 3/044

(52) U.S. Cl. CPC G06F 3/0414; G06F 3/044; G06F 3/0416

(57) ABSTRACT

Disclosed are method and terminal for detecting grip force. The method according to the embodiment of the present disclosure includes: acquiring operation information of the user in an edge touch area of the terminal; and acquiring the grip force detection result of the user according to the operation information of the user in the edge touch area of the terminal. The method and terminal for detecting grip force according to the embodiment of the present disclosure solve the problem of low detection efficiency in the prior art because the pinch meter is not portable, and fails to detect grip force at any time, thereby improving the detection efficiency.

### CROSS REFERENCE TO RELATED APPLICATIONS

This application is a continuation-in-part of International Application No. PCT/CN2016/096284, filed on Aug. 22, 2016, which is based upon and claims priority to Chinese Patent Application No. 2016101803069, filed on Mar. 25, 2016, the entire contents of which are incorporated herein by reference.

### TECHNICAL FIELD

The present disclosure relates to the technical field of communication, and, particularly relates to a method and terminal for detecting grip force.

### BACKGROUND

With the development of the science and technology, intelligent terminals are increasingly more and more popularized. Meanwhile, the users' living standard is also continuously improved, so that users attach increasingly more importance to management of their own health. Therefore, increasingly more devices and terminals for health management are combined to facilitate users to detect their own health at any time.

There are a variety of detection types. For example, a wearable device is used for detecting the heartbeat frequency, daily walking steps, and the like. However, health management is not limited to the detection of heartbeat frequency and walking steps, and may also be used for the detection of grip force of users.

In the process of implementing the present disclosure, the inventor found that the prior art at least has the following problems: In the prior art, a pinch meter is used for detecting the grip force in most cases. The pinch meter is not portable, so that users can only detect the grip force where there is a pinch meter. Therefore, failure to detect the grip force results in low detection efficiency.

### SUMMARY

In view of this, the present disclosure provides a method and terminal for detecting grip force for solving the problem of low detection efficiency in the prior art because the pinch meter is not portable, and fails to detect grip force at any time.

In order to achieve the above object of the disclosure, on the one hand, the embodiment of the present disclosure provides a method for detecting grip force, including: acquiring an operation information of a user in an edge touch area of the terminal; acquiring a grip force detection result of the user according to the operation information of a user in an edge touch area of the terminal.

The method for detecting grip force according to the embodiment of the present disclosure includes the following steps of acquiring the operation information of a user in an edge touch area of a terminal, and acquiring the grip force detection result of the user according to the operation information of the user in the edge touch area of the terminal.

The embodiment of the present disclosure performs a grip force detection by an operation in an edge touch area, so as to solve the problem of low detection efficiency in the prior art because the pinch meter is not portable, and fails to detect grip force at any time. The embodiment can detect users' grip force at any time, thereby improving the detection efficiency.

In order to achieve the above object of the disclosure, on the other hand, the embodiment of the present disclosure further provides a terminal, including: at least one processor; and, a memory connected with the at least one processor in a communicating way; wherein, the memory stores instructions that can be executed by the at least one processor, and the instructions are executed by the at least one processor, so that the at least one processor executes the method provided in various aspects mentioned above.

In order to achieve the above object of the disclosure, on the other hand, the embodiment of the present disclosure provides a computer program product including a computer program stored in a non-transitory computer-readable storage medium, wherein the computer program includes program instructions that, when being executed by a computer, cause the computer to execute the method provided in various aspects mentioned above.

### BRIEF DESCRIPTION OF THE DRAWINGS

One or more embodiments are illustrated by way of examples, and not by limitation, in the figures of the accompanying drawings, wherein elements having the same reference numeral designations represent like elements. The drawings are not to scale, unless otherwise disclosed.

FIG. 1 is a flow chart of embodiment 1 of the method for detecting grip force provided by some embodiments of the present disclosure;

FIG. 2 is a flow chart of embodiment 2 of the method for detecting grip force provided by some embodiments of the present disclosure;

FIG. 3 is a first schematic diagram of the terminal according to some embodiments of the present disclosure;

FIG. 4 is a second schematic diagram of the terminal according to some embodiments of the present disclosure;

FIG. 5 is a hardware schematic diagram of an terminal executing method for detecting grip force provided by some embodiments of the present disclosure.

### DETAILED DESCRIPTION

The preferred embodiments of the present disclosure are described in conjunction with the appended drawings below, and it should be understood that the preferred embodiments described herein are only presented to illustrate and explain the present disclosure, and are not intended to limit the present disclosure.

It should be clear that only a part of the embodiments, instead of all embodiments, of the present disclosure are presented. Based on the embodiments of the present disclosure, all other embodiments concluded by those skilled in the art without making inventive labor fall within the scope of protection of the present disclosure.

As used in the embodiments of the present disclosure, the terms are intended to describe specific embodiments only, and are not intended to limit the present disclosure. The singular forms of “a”, “said” and “the” used in the embodiments and appended claims of the present disclosure are also intended to include a plurality of forms, except to the extent that the context in which they are used for indicating otherwise.

Depending on the context, as used herein, the word “if” can be interpreted as “at the time of” or “when” or “in response to determination” or “in response to detection”. Similarly, depending on the context, the phrase “if it is determined” or “if it is detected (indicated conditions or event)” may be interpreted as “when determining” or “in response to determination” or “when detecting (indicated conditions or event)” or “in response to detection (indicated conditions or event).”

### Embodiment 1

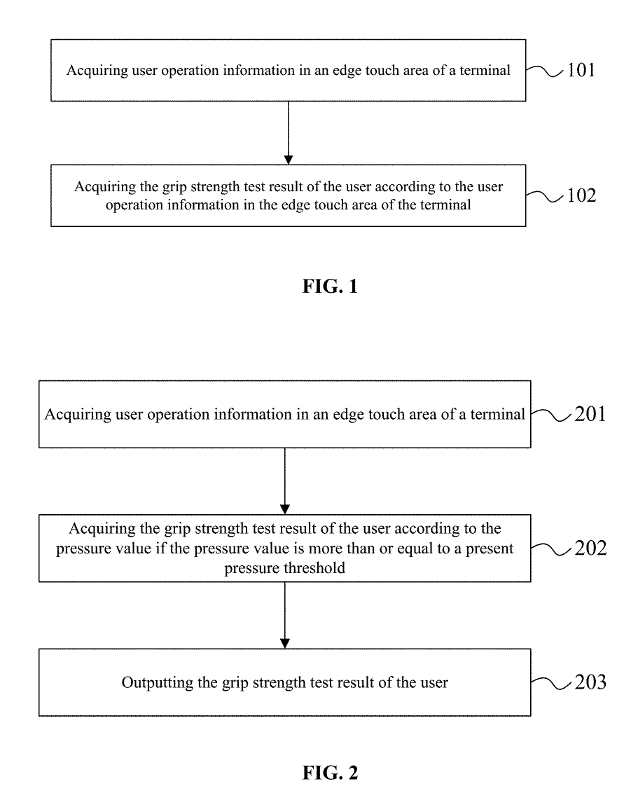

FIG. 1 is a flow chart of embodiment 1 of method for detecting grip force according to the embodiment of the present disclosure. As shown in FIG. 1, the method for detecting grip force according to the embodiment may specifically include the following steps.

101: the operation information of a user in an edge touch area of a terminal is acquired.

Grip force mainly reflects the muscle force of hands, forearms and upper extremity, and the human grip force is an important factor reflecting the viability and activity of a person. In daily life, grip force is usually taken as one of the physical fitness detection items, and is usually measured by a pinch meter. The pinch meter is not portable in everyday life, thereby resulting in low timeliness of the user detect.

Therefore, the embodiment provides a method for detecting grip force, and is intended to provide users with a method for detecting grip force via a terminal, so that the user can detect their grip force using a terminal at any time according to their own needs.

Firstly, user's operation behavior in an edge touch area of a terminal is monitored, so as to acquire the operation information of the user in the edge touch area of the terminal.

It is necessary to indicate that, the terminal involved in the embodiment of the present disclosure may include, but is not limited to, a personal computer (PC), a personal digital assistant (PDA), a wireless handheld device, a tablet computer, a mobile phone, an MP3 player, an MP4 player, etc., and the terminal has a screen.

According to the embodiment of the present disclosure, the operation information of the user in an edge touch area of a terminal may include, but is not limited to: the operation information generated from a pressing operation by the user in the edge touch area of the terminal.

It is understandable that, an edge touch control means to provide touch input through an edge, a side frame or the back of a terminal and track the clicking, sliding or pressing operation of finger on the terminal edge, so as to achieve the control to the terminal.

An edge touch area of a terminal may be an area accessible to a user's thumb on a side of the terminal when the user naturally holds the terminal, and the side of the terminal may include other four sides except the front side and back side.

According to the embodiment of the present disclosure, an edge touch area of a terminal may be implemented using physical buttons, virtual buttons, sensors or screens, etc.

Secondly, according to the embodiment of the present disclosure, the number of edge touch areas of a terminal is an even number, and the even numbered edge touch areas are set oppositely. For example, an edge touch area may be located on two sides including left side and right side of a terminal, or an edge touch area may also be located on two sides including upper side and lower side of a terminal, or an edge touch area may also be located on four sides including upper, lower, left and right sides.

For example, if a terminal uses a curved surface screen, an edge touch area of the terminal may be implemented using the edge screen of the curved surface screen. Illustrated by a capacitive touch screen, for example, when a user's finger touches the edge touch screen, a contact capacitance will be changed, so that the frequency of an oscillator connected with the capacitor changes, the touch position can be determined by measuring the frequency change of the oscillator, and then the operation information of the user in the edge touch area of the terminal can be acquired.

For another example, if there are physical buttons for volume adjustment on the edge of a terminal, description is provided with the physical button for volume adjustment on the terminal as an example: when a user's finger presses a physical button for volume adjustment, the terminal will know whether the user presses the volume up button or presses the volume down button. Similarly, when a user presses the edge touch area, the terminal can acquire the operation information of the user in the edge touch area of the terminal.

For another example, if there are virtual buttons with certain functions on the edge of a terminal, and the virtual buttons are capacitive virtual buttons, the terminal determines which virtual button is touched by a user through the capacitance of the capacitive virtual button. Specifically, when a user touches a capacitive virtual button, the finger will form a capacitor with an electrode tab in the capacitive virtual button, and the terminal determines the user touch position by detecting the capacitance change, thereby determining which virtual button is touched by the user, and then acquiring the operation information of the user in the edge touch area of the terminal.

For another example, if there are sensors with certain functions on the edge of a terminal, the sensors on the terminal, e.g. a pressure sensor, are taken as an example: when a user presses the pressure sensor, a semiconductor deformation pressure is formed on the surface of the pressure sensor sheet, and a piezoelectric impedance effect is generated by sheet deformation due to pressing, so that the impedance change is converted into an electrical signal. After acquiring the electrical signal, the terminal can determine which pressure sensor or which position on the pressure sensor is pressed by the user, so as to determine which function the pressure sensor pressed by the user has, and then acquiring the operation information of the user in the edge touch area of the terminal. In addition, a sensor with certain functions on the edge of a terminal may also be a light sensor.

102: Grip force detection result of a user is acquired according to the operation information of the user in an edge touch area of a terminal.

A user performs the grip force detection through an edge touch area of a handheld terminal. Before the detection, the grip force detection function of the terminal can be turned on, so that the terminal continuously monitors user operation in edge touch areas of the terminal, and then acquires pressing operation information according to the user's pressing operation in an edge touch area of the terminal. And it is clear that the user is performing the grip force detection according to the corresponding pressing operation information, thereby acquiring the corresponding grip force detection result.

For example, if a terminal uses a curved surface screen, the edge touch area of the terminal can be implemented using the edge screen of the curved surface screen. Description is provided with a capacitive touch screen as an example: when a user presses an edge touch area on left and right sides of a terminal by holding the terminal, the terminal acquires the operation information of the user in an edge touch area of the terminal, then monitors the pressing pressure intensity, and gets the corresponding grip force detection result.

Alternatively, if there is a physical button respectively on left side and right side of a terminal, when a user simultaneously presses the physical buttons on left side and right side by holding the terminal, the terminal acquires the operation information of the user in an edge touch area of the terminal, and then it is clear that the user is performing a grip force detection according to the corresponding pressing operation information, thereby acquiring the corresponding grip force detection result.

Alternatively, if there are virtual buttons with certain functions respectively on upper side and lower side of a terminal, and the virtual buttons are capacitive virtual buttons, when a user simultaneously presses the virtual buttons on upper and lower sides of the terminal by fingers, the terminal acquires the operation information of the user in an edge touch area of the terminal, and then it is clear that the user is performing a grip force detect according to the corresponding pressing operation information, thereby acquiring the corresponding grip force detection result.

The method for detecting grip force according to the embodiments of the present disclosure acquires operation information of the user in an edge touch area of a terminal, and acquires the grip force detection result of the user according to the operation information of the user in the edge touch area of the terminal. The embodiment of the present disclosure performs a grip force detection by an operation in an edge touch area, thereby solving the problem of low detection efficiency in the prior art because the pinch meter is not portable, and fails to detect grip force at any time. The embodiment can detect users' grip force at any time, thereby improving the detection efficiency.

### Embodiment 2

FIG. 2 is a flow chart in accordance with embodiment 2 of the method for detecting grip force according to some embodiments of the present disclosure. As shown in FIG. 2, the method for detecting grip force according to the embodiment may specifically include the following steps.

201: the operation information of a user in an edge touch area of a terminal is acquired.

Step 101 of the above embodiment provided details of the process of acquiring operation information of the user generated by a pressing operation in an edge touch area of a terminal. The principle and the implementation process of the embodiment of the present disclosure are the same, and are not repeated any more here.

It is necessary to indicate that in the embodiment, description is provided by taking the operation information of the user generated by a pressing operation in an edge touch area of a terminal is a pressure value as an example.

202: Grip force detection result of a user is acquired according to the pressure value if the pressure value is equal to or more than a preset pressure threshold.

When using a terminal, a user will press the terminal by pressures of different intensities due to different use conditions. Therefore, a pressure threshold may be preset in the terminal, in order to identify whether the user is normally holding the terminal, or is performing a grip force detection. When a user presses an edge touch area of the terminal, the pressure value is compared with the preset pressure threshold. If the pressure value is more than the preset pressure threshold, the user is detecting grip force, and then the grip force detection result of the user can be acquired according to the pressure value.

Wherein, the preset pressure threshold may be a pressure value that is generated by a pressing operation of a user in an edge touch area of a terminal when starting grip force detection, and the terminal stores the said pressure value in the terminal as a pressure threshold.

The process of acquiring grip force value by a pressure value may be includes: when a user holds a terminal, an edge touch area of the terminal is under pressure, and different electrical signals are generated by the pressure acting area change of the hand. After processing by a pressure sensor according to the electrical signals, the electrical signals are transmitted to a processing module of the terminal. Then the processing module acquires a pressure value in accordance with the received electrical signals, and then calculates the grip force value, i.e., the grip force detection result, based on the conversion formula between pressure value and grip force value.

For example, when a user holds edge touch areas on left and right sides of a terminal, and exerts certain pressure on the edge touch areas of the terminal, then the terminal acquires the pressure value of the user, and gets the user's grip force value of 20KG through conversion by the processing module of the terminal.

In addition, if the pressure value is less than a preset pressure threshold, then it can be concluded according to the pressure value that a user is only holding a terminal, rather than performing the grip force detection. Therefore, the current process is finished without calculating the grip force value based on the pressure value.

203: The grip force detection result of the user is output.

After acquiring the corresponding result of a grip force detect, the user may store and output the result.

The grip force detection result may be stored in a grip force detect application installed in a terminal, or may also be stored in the internal storage of a terminal, or may also be sent by a terminal to a server, and stored in the server, etc.

The grip force detection result may be output to a page of a grip force detect application installed in a terminal to inform the user of the grip force detection result, and the results of a plurality of detects may be recorded. Alternatively, the grip force detection result may also be directly displayed on a screen; or, may also be output to a server for data collection or statistics.

For example, a user installs a grip force detect application in a terminal. After entering a grip force detect page, the user begins grip force detect, and displays and records the detection results, if available, on a grip force detect page. The results of a plurality of detects of the user can all be recorded in the application, so that the user can monitor its own health conditions according to the corresponding data.

The method for detecting grip force according to the embodiment of the present disclosure is used for acquiring the grip force detection result of the user by acquiring the operation information of the user in an edge touch area of a terminal, and comparing the pressure value of the user in the edge touch area of the terminal with a preset pressure threshold. The embodiment of the present disclosure performs a grip force detect by an operation in an edge touch area, thereby solving the problem of low detection efficiency in the prior art because the pinch meter is not portable, and fails to detect grip force at any time. The embodiment can detect users' grip force at any time, thereby improving the detection efficiency.

### Embodiment 3

The embodiment of the present disclosure further provides an embodiment of a device for implementing various steps and methods according to the embodiment of the above method.

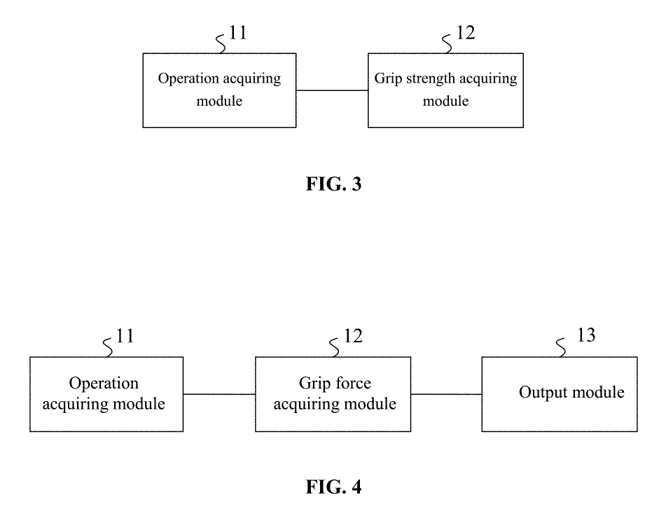

FIG. 3 is a first schematic diagram of the terminal according to the embodiment of the present disclosure. As shown in FIG. 3, the terminal according to the embodiment of the present disclosure includes an operation acquiring module 11 and a grip force acquiring module 12.

The operation acquiring module 11 is used for acquiring the operation information of the user in an edge touch area of the terminal;

The grip force acquiring module 12 is used for acquiring grip force detection result of the user according to the operation information of the user in an edge touch area of the terminal acquired by the operation acquiring module 11;

Wherein, operation information of the user in an edge touch area of the terminal includes: operation information of the user generated by a pressing operation in the edge touch area of the terminal.

It is necessary to indicate that, the number of edge touch areas of the terminal according to the embodiment is an even number, and the even-numbered edge touch areas are set oppositely.

The terminal according to the embodiment of the present disclosure can be used for executing the technical solution according to the embodiment of the method shown in FIG. 1. Its implementation principle and technical effect are similar, and are not repeated any more here.

The terminal according to the embodiment of the present disclosure acquires operation information of the user in an edge touch area of the terminal by the acquiring module 11, and acquires the grip force detection result of the user according to the operation information of the user in the edge touch area of the terminal by the result acquiring module 12. The embodiment of the present disclosure performs a grip force detect by an operation in an edge touch area, thereby solving the problem of low detection efficiency in the prior art because the pinch meter is not portable, and fails to detect grip force at any time. The embodiment can detect users' grip force at any time, thereby improving the detection efficiency.

### Embodiment 4

FIG. 4 is a second schematic diagram of the terminal according to the embodiment of the present disclosure. As shown in FIG. 4, on the basis of the above embodiments, the terminal according to the embodiment of the present disclosure further includes an output module 13.

Furthermore, operation information of the user generated by a pressing operation in an edge touch area of the terminal is a pressure value; the grip force acquiring module 12 is specifically used for acquiring grip force detection result of a user according to the pressure value if the pressure value is equal to or more than a preset pressure threshold.

The output module 13 is used for outputting the grip force detection result of a user.

The terminal according to the embodiment of the present disclosure can be used for executing the technical solution according to the embodiment of the method shown in FIG. 2. Its implementation principle and technical effect are similar, and are not repeated any more here.

The terminal according to the embodiment of the present disclosure acquires operation information of the user in an edge touch area of the terminal by the operation acquiring module 11, acquires the grip force detection result of the user by the grip force acquiring module 12 through comparison of the pressure value of the user in the edge touch area of the terminal with a preset pressure threshold, and finally outputs the grip force detection result of the user by the output module 13. The embodiment of the present disclosure performs a grip force detect by an operation in an edge touch area, thereby solving the problem of low detection efficiency in the prior art because the pinch meter is not portable, and fails to detect grip force at any time. The embodiment can detect users' grip force at any time, thereby improving the detection efficiency.

### Embodiment 5

The embodiment of the present disclosure provides a non-volatile computer storage medium storing computer-executable instructions that can execute the processing method in the embodiment of any of the above methods.

### Embodiment 6

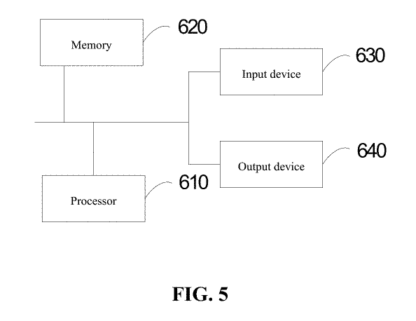

FIG. 5 is a hardware schematic diagram of an electronic device executing the method for detecting grip force according to the embodiment of the present disclosure. As shown in FIG. 5, the device includes one or more processors 610 and a memory 620. A processor 610 is taken as an example in FIG. 5. The device may further include: an input device 630 and an output device 640.

The processor 610, the memory 620, the input device 630 and the output device 640 can be connected with a bus or by other means. Bus connection is taken as an example in FIG. 6.

As a non-volatile computer-readable storage medium, the memory 620 can be used for storing non-volatile software programs, non-volatile computer-executable programs and modules. The processor 610 runs non-volatile software programs, instructions and modules which are stored in the memory 620, so as to execute various function applications of an electronic device and data processing, that is, implementing the processing method according to the embodiments of the above methods.

The memory 620 may include a program storage area and a data storage area, wherein, the program storage area may store an operating system and applications required by at least one function; the data storage area may store, e.g., data. In addition, the memory 620 may include a high-speed random access memory, and may further include a non-volatile memory, such as at least one disk memory device, a flash memory device, or other non-volatile solid-state memory devices. In some embodiments, the memory 620 may optionally include memories arranged remotely relatively to the processor 610, and these remote memories can be connected to the processing unit over network. Examples of the above networks include, but not limited to the Internet, intranets, LANs, mobile communication networks and combinations thereof.

The input device 630 receives input number or character information, and generates signal input. The output device 640 may include a display screen and other display devices.

The one or more modules are stored in the memory 620, when executed by the one or more processors 610, acquires operation information of the user in an edge touch area of the terminal; acquires the grip force detection result of the user according to the operation information of the user in the edge touch area of the terminal.

According to one of possible implementation ways, the operation information of the user in an edge touch area of the terminal includes: the operation information of the user generated by a pressing operation in the edge touch area of the terminal.

According to one of possible implementation ways, the number of edge touch areas of the terminal is an even number, and the even-numbered edge touch areas are set oppositely.

According to one of possible implementation ways, the operation information of the user generated by a pressing operation in an edge touch area of the terminal is a pressure value; the acquisition of the grip force detection result of the user according to the operation information of the user in the edge touch area of the terminal includes: the grip force detection result of the user is acquired according to the pressure value if the pressure value is equal to or more than a preset pressure threshold.

According to one of possible implementation ways, the method further includes: the grip force detection result of the user is output.

The product can execute the method provided by the embodiment of the present disclosure, and has corresponding function modules for performing the method and beneficial effects. About the technical details that are not described in detail in this embodiment, please refer to the method provided by the embodiment of the present disclosure.

The electronic device provided by the embodiment of the present disclosure exists in a variety of forms, including but not limited to:

Mobile communication devices: the characteristics of such devices are that they have mobile communication functions, and mainly aim to provide voice and data communication. Such terminals include: smartphones (e.g. iPhone), multimedia mobile phones, functional mobile phones, low-end mobile phones, etc.

Ultra-mobile PC device: Such devices belong to the category of PC, have calculating and processing functions, and usually also have mobile Internet features. Such terminals include: PDA, MID, UMPC devices, etc., e.g. iPad.

Portable entertainment device: Such devices can display and play multimedia contents. Such devices include: audio, video players (e.g. iPad), handheld game players, e-books, smart toys and portable vehicle navigation devices.

Server: A device providing computing service. The server components include a processor, a hard drive, an internal memory, a system bus, etc. Structure of the server is similar to that of a general computer. But because of the need of providing highly reliable service, the requirements in respect of the processing capacity, stability, reliability, security, scalability, manageability, etc. are very high.

Other electronic devices with data interaction functions.

The embodiments of the devices described above are presented by way of examples only, wherein the units described as separate components may be or may also not be physically separated, and the components shown as a unit may be or may also not be a physical unit, i.e., may be located in one place, or may also be distributed to a plurality of network units. According to the actual need, part or all of the modules thereof are selected to achieve the object of the solution of this embodiment.

Through the description of the above embodiments, it should be clearly understood for those skilled in the art that various embodiments may be implemented using software with the addition of a universal hardware platform, and of course, may also be implemented by hardware. Based on such understanding, the above technical solution may be essentially reflected or the parts thereof making contribution to related technology may be reflected in the form of software products. The computer software products can be stored in the computer readable storage medium, e.g. ROM/RAM, disk, CD, and the like, including a number of instructions for causing a computer device (a PC, a server, or a network device, etc.) to execute the methods according to various embodiments or some parts of the embodiments.

Finally, it is necessary to indicate that: the above embodiments are only presented to show the technical solutions of this application, rather than limiting them. This application is described in detail with reference to the preceding embodiments, it should be understood for those skilled in the art that they can still modify the technical solutions according to various preceding embodiments, or equivalently replace part of the technical features thereof; and these modifications or replacements do not cause the essence of corresponding technical solutions to depart from the spirit and scope of the technical solutions according to various embodiments of this application.

What is claimed is:

1. A method for detecting grip force, executed by a terminal, comprising:
acquiring an operation information of a user in an edge touch area of the terminal;
acquiring a grip force detection result of the user according to the operation information of a user in an edge touch area of the terminal.

2. The method according to claim 1, wherein the operation information of a user in an edge touch area of the terminal comprises:
the operation information generated from a pressing operation by the user in the edge touch area of the terminal.

3. The method according to claim 1, wherein the number of edge touch areas of the terminal is an even number, and the even-numbered edge touch areas are set oppositely.

4. The method according to claim 2, wherein the operation information generated from a pressing operation by the user in the edge touch area of the terminal is a pressure value;
the acquiring a grip force detection result of the user according to the operation information of a user in an edge touch area of the terminal comprises:
acquiring the grip force detection result of the user according to the pressure value, if the pressure value is equal to or more than a preset pressure threshold.

5. The method according to claim 1, wherein the method further comprises:
outputting the grip force detection result of the user.

6. A terminal, comprising:
at least one processor; and,
a memory connected with the at least one processor in a communicating way;
wherein, the memory storing the instructions that can be executed by the at least one processor, wherein the instructions are executed by the at least one processor, so that the at least one processor is used for:
acquiring an operation information of a user in an edge touch area of the terminal;
acquiring a grip force detection result of the user according to the operation information of a user in an edge touch area of the terminal.

7. The terminal according to claim 6, wherein the operation information of a user in an edge touch area of the terminal comprises:
the operation information generated from a pressing operation by the user in the edge touch area of the terminal.

8. The terminal according to claim 6, wherein the number of edge touch areas of the terminal is an even number, and the even-numbered edge touch areas are set oppositely.

9. The terminal according to claim 7, wherein the operation information generated from a pressing operation by the user in the edge touch area of the terminal is a pressure value;
the acquiring a grip force detection result of the user according to the operation information of a user in an edge touch area of the terminal comprises:
acquiring the grip force detection result of the user according to the pressure value, if the pressure value is equal to or more than a preset pressure threshold.

10. The terminal according to claim 6, wherein, the instructions are executed by the at least one processor, so that the at least one processor is used for:
outputting the grip force detection result of the user.

11. A non-transitory computer-readable storage medium, storing computer-executable instructions which are used for:
acquiring an operation information of a user in an edge touch area of the terminal;
acquiring a grip force detection result of the user according to the operation information of a user in an edge touch area of the terminal.

12. The non-transitory computer-readable storage medium according to claim 11, wherein the operation information of a user in an edge touch area of the terminal comprises:
the operation information generated from a pressing operation by the user in the edge touch area of the terminal.

13. The non-transitory computer-readable storage medium according to claim 11, wherein the number of edge touch areas of the terminal is an even number, and the even-numbered edge touch areas are set oppositely.

14. The non-transitory computer-readable storage medium according to claim 12, wherein the operation information generated from a pressing operation by the user in the edge touch area of the terminal is a pressure value;
the acquiring a grip force detection result of the user according to the operation information of a user in an edge touch area of the terminal comprises:
acquiring the grip force detection result of the user according to the pressure value, if the pressure value is equal to or more than a preset pressure threshold.

15. The non-transitory computer-readable storage medium according to claim 11, wherein the computer-executable instructions are used for:
outputting the grip force detection result of the user.
